(19) United States
(12) Patent Application Publication
(10) Pub. No.: US 2023/0118740 A1
(43) Pub. Date: Apr. 20, 2023

(54) CHARGING MANAGEMENT DEVICE, CHARGING MANAGEMENT SYSTEM, AND CHARGING MANAGEMENT METHOD

(71) Applicant: Panasonic Intellectual Property Management Co., Ltd., Osaka (JP)

(72) Inventors: Akihiko IGUCHI, Osaka Fu (JP); Takamasa UEDA, Kanagawa Ken (JP); Takuma IIDA, Kanagawa Ken (JP)

(73) Assignee: PANASONIC INTELLECTUAL PROPERTY MANAGEMENT CO., LTD., Osaka (JP)

(21) Appl. No.: 18/083,933

(22) Filed: Dec. 19, 2022

Related U.S. Application Data
(63) Continuation of application No. PCT/JP2021/024866, filed on Jun. 30, 2021.

(30) Foreign Application Priority Data
Jun. 30, 2020 (JP) 2020-113174

(51) Int. Cl. H02J 7/00; B60L 53/62

(52) U.S. Cl. CPC H02J 7/0071; B60L 53/62; H02J 7/0047

(57) ABSTRACT

A charging management device according to the present disclosure includes a memory and a processor coupled to the memory. The processor is configured to: create a charging plan for inhibiting deterioration of a battery mounted on a moving object based on power consumption of the moving object predicted from a delivery plan and a characteristic of the battery; and determine whether the charging plan is replanned based on a reference battery power amount calculated in accordance with a remaining time period up to a target time point at which a target power amount indicated by the charging plan is achieved, when the remaining time period is shorter than a predetermined first time period in charging to the battery performed in accordance with the charging plan.

### CROSS-REFERENCE TO RELATED APPLICATIONS

This application is a continuation of International Application No. PCT/JP2021/024866, filed on Jun. 30, 2021 which claims the benefit of priority of the prior Japanese Patent Application No. 2020-113174, filed on Jun. 30, 2020, the entire contents of which are incorporated herein by reference.

### FIELD

Embodiments described herein relate generally to a charging management device, a charging management system, and a charging management method.

### BACKGROUND

Various moving objects using a battery, such as an electric vehicle and a hybrid vehicle, have been conventionally used for various deliveries such as home delivery. Furthermore, for example, a technique of proposing a charging plan recommended from the viewpoint of inhibiting battery deterioration is known (e.g., see WO 2012/093638 A).

The present disclosure provides a charging management device, a charging management system, and a charging management method capable of appropriately managing an actual power amount of a battery in charging in consideration of inhibiting battery deterioration.

### SUMMARY

A charging management device according to the present disclosure includes a memory and a processor coupled to the memory. The processor is configured to: create a charging plan for inhibiting deterioration of a battery mounted on a moving object based on power consumption of the moving object predicted from a delivery plan and a characteristic of the battery; and determine whether the charging plan is replanned based on a reference battery power amount calculated in accordance with a remaining time period up to a target time point at which a target power amount indicated by the charging plan is achieved, when the remaining time period is shorter than a predetermined first time period in charging to the battery performed in accordance with the charging plan.

### BRIEF DESCRIPTION OF THE DRAWINGS

FIG. 1 is a block diagram illustrating one example of a configuration of a management system according to an embodiment;

FIG. 2 is a block diagram illustrating one example of a hardware configuration of a display terminal according to the embodiment;

FIG. 3 is a block diagram illustrating one example of a hardware configuration of the management device according to the embodiment;

FIG. 4 is a block diagram illustrating one example of a functional configuration of the display terminal according to the embodiment;

FIG. 5 is a block diagram illustrating one example of a functional configuration of the management device according to the embodiment;

FIG. 6 illustrates charging management according to the embodiment;

FIG. 7 illustrates a reference battery power amount set in accordance with a remaining charging time period according to the embodiment;

FIG. 8 is a flowchart illustrating one example of charging management processing executed by the management device according to the embodiment;

FIG. 9 is a flowchart illustrating one example of the charging management processing executed by the display terminal according to the embodiment;

FIG. 10 illustrates one example of a display screen of the display terminal according to the embodiment;

FIG. 11 illustrates one example of the display screen of the display terminal according to the embodiment; and

FIG. 12 illustrates one example of the display screen of the display terminal according to the embodiment.

### DETAILED DESCRIPTION

An embodiment of a charging management device, a charging management system, and a charging management method according to the present disclosure will be described below with reference to the drawings. Note that, in the following embodiment, a “time point” indicates the time at a certain point. Furthermore, a “time period” indicates a width from a certain time point to another time point after the certain time point, that is, a range.

An example of a case where technology according to the present disclosure is applied to various deliveries such as home delivery will be described below Note that the technology according to the present disclosure can be applied not only to a case where baggage is transported but a case where a person is transported such as ride-sharing, a shared taxi, and a shared bus. Furthermore, the technology according to the present disclosure can also be applied to a case where a plurality of users uses the same moving object such as a rental car and a rental cycle.

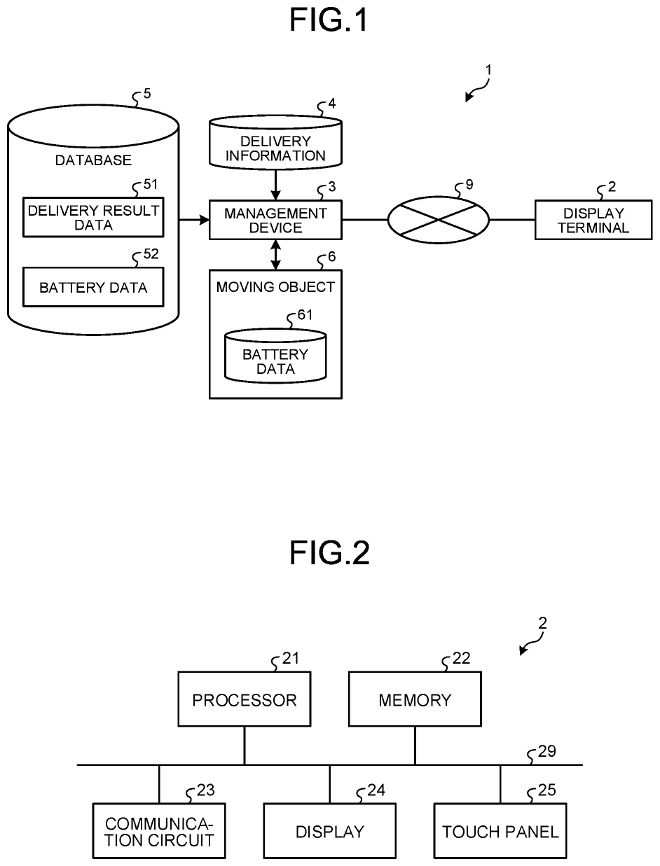

FIG. 1 is a block diagram illustrating one example of a configuration of a management system 1 according to the embodiment. The management system 1 according to the embodiment is a delivery management system that manages delivery of various articles to a plurality of delivery destinations, and is also a charging management system that manages charging to a battery mounted on a moving object 6 used for delivery. Here, the plurality of delivery destinations is one example of a plurality of destinations. Note that, although FIG. 1 illustrates the management system 1 including one moving object 6, this is not a limitation. The management system 1 may include two or more moving objects 6.

As illustrated in FIG. 1, the management system 1 includes a display terminal 2 and a management device 3. The display terminal 2 and the management device 3 are communicably connected to each other via a network 9. An electric communication line such as the Internet can be used as the network 9. In one example, the management system 1 can be constructed as a server-client type system including the display terminal 2 serving as a client device and the management device 3 serving as a server device. A smartphone, a tablet PC, a car navigation system, and the like can be appropriately used as the display terminal 2. A server device, a PC, and the like can be appropriately used as the management device 3.

The display terminal 2 is a device that displays information such as a delivery plan, a charging plan, and a charging result regarding each of the plurality of moving objects 6. The management device 3 supplies the information such as a delivery plan, a charging plan, and a charging result displayed on the display terminal 2. The management device 3 prepares a delivery plan and a charging plan for each of a plurality of delivery vehicles. Furthermore, the management device 3 acquires information such as an actual power amount and deterioration amount of the battery of the moving object 6. Here, the management device 3 is one example of the charging management device.

Here, the charging plan is made for charging a battery mounted on a delivery vehicle. The charging plan is prepared in accordance with a delivery plan from the viewpoint of inhibiting battery deterioration. The charging plan is executed between deliveries, for example, at night. The charging plan includes a charging time period and a charging pause time period from the viewpoint of inhibiting battery deterioration. Furthermore, the delivery plan is information indicating a delivery route. The delivery plan is prepared from the viewpoint of inhibiting battery deterioration. The delivery plan is created so as to reduce values of a power consumption amount and a battery deterioration amount predicted in the case where delivery is performed by using the delivery route. Furthermore, the charging result is information indicating a value of an actual power amount at the time when a battery mounted on a delivery vehicle is charged in accordance with a charging plan, that is, a result value.

FIG. 2 is a block diagram illustrating one example of a hardware configuration of the display terminal 2 according to the embodiment. As illustrated in FIG. 2, the display terminal 2 includes a processor 21, a memory 22, a communication circuit 23, a display 24, and a touch panel 25. The processor 21, the memory 22, the communication circuit 23, the display 24, and the touch panel 25 are communicably connected via, for example, a bus 29.

The processor 21 controls the overall operation of the display terminal 2. The memory 22 stores various pieces of data and programs used in the display terminal 2. The data stored in the memory 22 includes data received from the management device 3. The program stored in the memory 22 includes a charging management program on the side of a terminal to be described later. The communication circuit 23 is used for communicating with the outside of the display terminal 2 via the network 9. The display 24 presents a display screen to a user. A liquid crystal display, an organic EL display, a projector, and the like can be appropriately used as the display 24. The touch panel 25 receives user input. The touch panel 25 is provided on the surface of the display 24, and outputs information in accordance with a touched position.

Note that the display terminal 2 may include an input device other than the touch panel 25, such as a keyboard. Furthermore, the display terminal 2 may further include a microphone and a speaker. The microphone receives user voice input. The speaker outputs voice in accordance with voice data. In these cases, in the display terminal 2, the content of the display screen including a notification of re-planning and a notification of a target nonattainment error to be described later may be presented to the user by voice, or responses to these notifications may be input by voice.

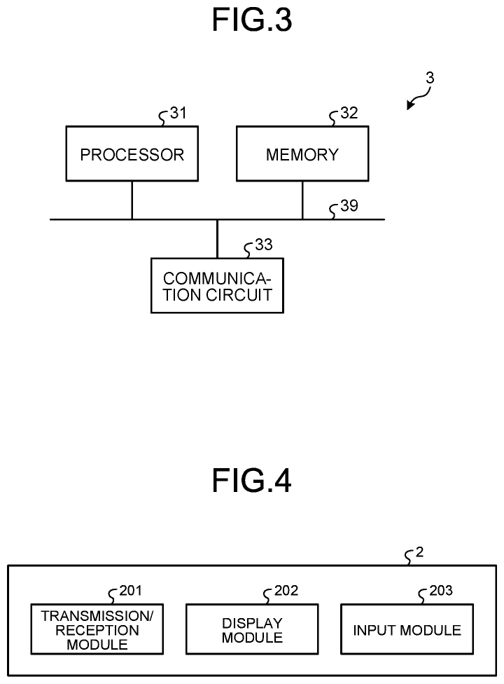

FIG. 3 is a block diagram illustrating one example of a hardware configuration of the management device 3 according to the embodiment. As illustrated in FIG. 3, the management device 3 includes a processor 31, a memory 32, and a communication circuit 33. The processor 31, the memory 32, and the communication circuit 33 are communicably connected via, for example, a bus 39.

Note that the management device 3 may be connected so as to be able to access at least one of a database storing delivery information 4, a database 5, and the moving object 6 via the network 9. Furthermore, the management device 3 may be configured so as to be able to access at least one of the database storing the delivery information 4, the database 5, and the moving object 6 via a computer-readable recording medium or a portable external storage device. For example, a CD-ROM, a flexible disk (FD), a CD-R, and a digital versatile disk (DVD) can be appropriately used as the computer-readable recording medium. Furthermore, a hard disk drive (HDD), a solid state drive (SSD), a flash memory, and the like can be appropriately used as the portable external storage device.

The processor 31 controls the overall operation of the management device 3. The memory 32 stores various pieces of data and programs used in the management device 3. The data stored in the memory 32 includes data received from the display terminal 2, the database storing the delivery information 4, the database 5, and the moving object 6. The program stored in the memory 32 includes a charging management program on the side of a server to be described later. The communication circuit 33 is used for communicating with the outside of the management device 3.

Note that the management device 3 may include an input device that receives a user input, such as a touch panel and a keyboard. Furthermore, the management device 3 may include a display device that presents a display screen to the user, such as a liquid crystal display, an organic EL display, and a projector.

Furthermore, as illustrated in FIG. 1, the management system 1 includes the database storing the delivery information 4, the database 5, and the moving object 6. In the management system 1, the management device 3 is connected so as to be able to access each of the database storing the delivery information 4, the database 5, and the moving object 6.

The database storing the delivery information 4 is stored in, for example, a computer and a data server managed by a company to which a delivery driver belongs. The delivery information 4 is set for each driver or each moving object 6, and indicates a name or an address of a delivery destination of each of a plurality of pieces of baggage and a delivery time point and a delivery time period to the delivery destination. The delivery information 4 may include map data used for calculating a delivery course and information on traffic congestion occurring on a road. Furthermore, the delivery information 4 may include information such as the floor of a delivery destination, the presence or absence of an elevator, and the size, weight, and number of articles to be delivered to the delivery destination. Here, the delivery information 4 is one example of destination information.

The database 5 stores delivery result data 51 and battery data 52. The database 5 is stored in, for example, a computer and a data server managed by a company to which a delivery driver belongs. The delivery result data 51 is, for example, history data accumulated for each driver who is an operator of the moving object 6. The delivery result data 51 includes, for example, delivery information on performed delivery and information indicating a delivery route used, characteristics of the moving object 6 used, and the like. The characteristics of the moving object 6 include, for example, when the moving object 6 is a vehicle, the weight of the vehicle, the type of the vehicle such as whether the moving object 6 is an electric vehicle or a hybrid vehicle, the type of a mounted battery, and the presence or absence of a regenerative brake. The battery data 52 is information indicating characteristics of a battery mounted on the moving object 6 such as a delivery vehicle. The information indicating characteristics of a battery indicates, for example, the capacity, maximum output, rated output, and output fluctuation in accordance with a load of the battery.

The moving object 6 transports various articles to a plurality of delivery destinations. Various moving objects driven by using a battery can be appropriately used as the moving object 6. The moving object 6 is a delivery vehicle using a battery, such as an electric vehicle and a hybrid vehicle. The moving object 6 includes a processor, a memory, and a communication circuit similarly to the management device 3 in FIG. 3. The processor of the moving object 6 controls the overall operation of the moving object 6. The memory of the moving object 6 stores various pieces of data and programs used by the moving object 6. The data stored in the memory of the moving object 6 includes battery data 61. The communication circuit of the moving object 6 is used for communicating with the outside of the moving object 6.

The battery data 61 is information indicating a state of a battery mounted on the moving object 6. Note that the battery data 61 may include information indicating characteristics of a battery. The information indicating a state of a battery indicates, for example, a capacity at that time, that is, states of charge (SOC) indicating a charging state, states of health (SOH) indicating a deterioration state, temperature, and an energizing time period. As the SOH, a capacity maintenance rate indicating a capacity deterioration state as compared to that in an initial stage may be used, a resistance increase rate indicating resistance deterioration state as compared to that in the initial stage may be used, or both of these rates may be used.

Note that various vehicles such as a bicycle, a motorcycle, an automobile, and a train can be appropriately used as the moving object 6. Furthermore, the moving object 6 is not limited to these vehicles, and may be various moving objects using a battery, such as a ship and an aircraft. Furthermore, the moving object 6 may be moved in a manned manner or an unmanned manner. Furthermore, the movement of the moving object 6 may be controlled by the user, or may be autonomously controlled in accordance with a set delivery course and the like.

Various processors such as a central processing unit (CPU), a graphics processing unit (GPU), an application specific integrated circuit (ASIC), and a field programmable gate array (FPGA) can be appropriately used as the processor 21, the processor 31, and a processor of the moving object 6.

Various storage media and storage devices such as a read only memory (ROM), an HDD, an SSD, and a flash memory can be appropriately used as the memory 22, the memory 32, and the memory of the moving object 6. Furthermore, a random access memory (RAM) that temporarily stores data during an operation is further provided in each of the memory 22, the memory 32, and the memory of the moving object 6.

A communication circuit for wired communication, a communication circuit for wireless communication, and a combination thereof can be appropriately used as the communication circuit 23, the communication circuit 33, and the communication circuit of the moving object 6. A communication circuit compatible with various standards such as 3G, 4G, 5G, Wi-Fi (registered trademark), and Bluetooth (registered trademark) can be appropriately used as the communication circuit for wireless communication.

Note that the database storing the delivery information 4 and the database 5 may be stored in one server or the like, or may be stored in a distributed manner in a plurality of servers or the like. Furthermore, at least one of the database storing the delivery information 4 and the database 5 may be stored inside the display terminal 2, the management device 3, or the moving object 6.

Note that the database storing the delivery result data 51 and the database storing the battery data 52 are not limited to be configured as one database 5, and may be configured as different databases.

FIG. 4 is a block diagram illustrating one example of a functional configuration of the display terminal 2 according to the embodiment. The display terminal 2 implements functions of a transmission/reception module 201, a display module 202, and an input module 203 by the processor 21 executing a charging management program on the side of a terminal loaded in the memory 22, for example.

The transmission/reception module 201 receives a charging plan, a charging result, and a notification from the management device 3. The transmission/reception module 201 may transmit, to the management device 3, a user response received by the input module 203 to a notification of re-planning and a notification of a target nonattainment error. The display module 202 displays a display screen including the charging plan and the charging result. Furthermore, the display module 202 displays a display screen including a notification. The input module 203 may receive input or selection of a user response to the notification of re-planning or the notification of a target nonattainment error.

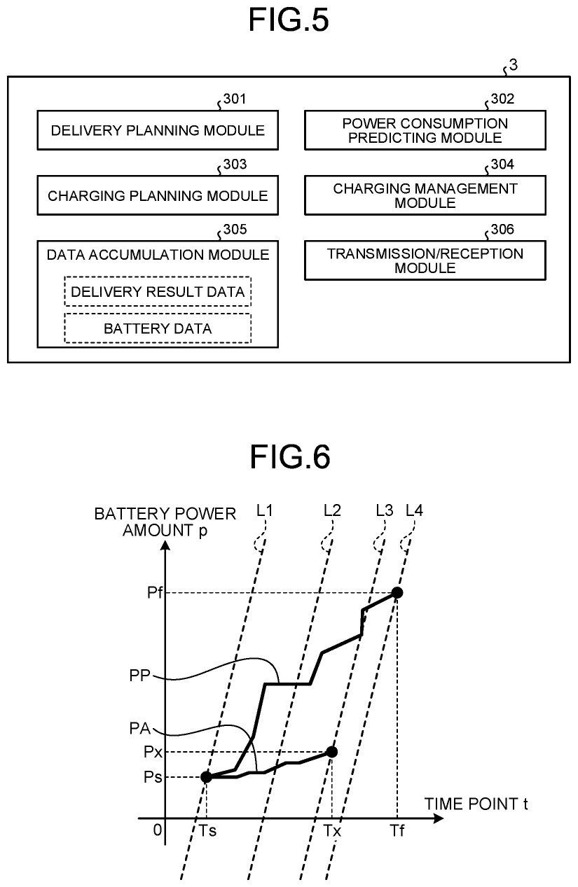

FIG. 5 is a block diagram illustrating one example of a functional configuration of the management device 3 according to the embodiment. The management device 3 implements functions of a delivery planning module 301, a power consumption predicting module 302, a charging planning module 303, a charging management module 304, a data accumulation module 305, and a transmission/reception module 306 by the processor 31 executing a charging management program on the side of a server loaded in the memory 32, for example.

The delivery planning module 301 creates a delivery course for inhibiting battery deterioration based on the delivery information 4 on a plurality of delivery destinations, the accumulated delivery result data 51, and the accumulated battery data 52. The power consumption predicting module 302 calculates a power consumption amount predicted in the case where delivery is performed in accordance with a delivery plan created by the delivery planning module 301. The charging planning module 303 creates a charging plan based on the prediction of the power consumption amount calculated by the power consumption predicting module 302. In one example, the charging planning module 303 creates the charging plan based on the delivery plan, the predicted power consumption amount, a battery power amount at the start of charging, a charging power amount per unit time period of a charger, and the battery data 61. The charging plan includes, for example, a charging start time point, a target time point of charging end, and a target battery power amount. The charging management module 304 manages charging of a battery of the moving object 6 in accordance with the charging plan. Specifically, the charging management module 304 determines whether the charging plan is replanned based on the difference between a target time point and the current time point, that is, a reference battery power amount set in accordance with a remaining charging time period. Details of charging management will be described later. The data accumulation module 305 accumulates the delivery result data 51 and the battery data 52. The transmission/reception module 306 receives delivery information from the database storing the delivery information 4. The transmission/reception module 306 receives the delivery result data 51 and the battery data 52 from the database 5 before the delivery plan and the charging plan are created. After completion of delivery, the transmission/reception module 306 transmits the delivery result data 51 and the battery data 52 to the database 5. The transmission/reception module 306 receives the battery data 61 from the moving object 6. The transmission/reception module 306 transmits the delivery plan, the charging plan, the charging result, and a notification to the display terminal 2. The transmission/reception module 306 receives a user response to a notification of re-planning and a notification of a target nonattainment error from the display terminal 2.

Note that, in the management system 1, a part or all of functions implemented by the management device 3 may be implemented in the display terminal 2 and the moving object 6.

Here, charging management according to the embodiment will be described in more detail with reference to the drawings.

Various moving objects using a battery, such as an electric vehicle and a hybrid vehicle, have been conventionally used for various deliveries such as home delivery. Furthermore, for example, a technique of proposing a charging plan recommended from the viewpoint of inhibiting battery deterioration is known. Unfortunately, when a battery is charged in accordance with a charging plan, an actual power amount of a battery may fail to reach a target power amount by a predetermined time point due to a battery state, a charging environment, and the like. The charging environment may include ambient temperature, battery temperature, deterioration of a charger or a charging cable, a power failure, instability of supply voltage, and power consumption in the moving object 6. When a charging result is insufficient to a charging plan, re-planning of the charging plan is necessary for supplementing an insufficient battery power amount.

Therefore, the management system 1 according to the embodiment is configured such that the management system 1 can appropriately manage an actual power amount of a battery in charging in consideration of inhibiting battery deterioration by determining whether a charging plan is replanned based on a reference battery power amount set in accordance with a remaining charging time period.

FIG. 6 illustrates charging management according to the embodiment. In the graph in FIG. 6, the vertical axis and the horizontal axis indicate a battery power amount p [kWh] and a time point t [hour], respectively. FIG. 6 illustrates one example of a charging plan PP and a charging result PA regarding the battery power amount.

In the charging plan PP in FIG. 6, charging starts at a time point Ts [hour], and a time point Tf [hour] is a target time point of charging end. Note that a battery power amount at the time point Ts of charging start is defined as a power amount Ps [kWh]. Furthermore, a battery power amount at the time point Tf which is a charging end target, that is, a target battery power amount is defined as a power amount Pf [kWh]. Here, the time point Tf which is a charging end target can be appropriately set at a time point before the time point of charging end. The time point of charging end is a limit time point at which charging is possible, for example, delivery start time point. In one example, the time period from the time point Ts at which charging starts to the target time point Tf is 90% of the time period from the time point at which charging can start to the time point of charging end. In another example, the time point Tf which is a charging end target is a predetermined time period before the time point of charging end.

The charging result PA in FIG. 6 illustrates one example of transition of a result value at the time when a battery mounted on the moving object 6 is charged in accordance with the charging plan. Note that charging starts at the time point Ts in the state of the power amount Ps. Furthermore, the battery power amount reaches a power amount Px [kWh] at any time point Tx.

Here, charging power of a charger at the time of rapid charging is defined as Cw [kW]. In the example in FIG. 6, the transition of the maximum power amount of the charger of the charging power Cw can be expressed by straight lines L1, L2, L3, and L4 of the inclination Cw. For example, the maximum amount of power that can be charged by the charging power Cw after the time point Ts transitions along the straight line L1. Similarly, the maximum amount of power that can be charged by the charging power Cw after the time point Tx transitions along the straight line L3. In this case, a maximum amount p′ [kWh] of power that can be charged by the target time point Tf after the time point Tx is expressed by Expression (1).

p′=Cw(Tf−Tx) (1)

Therefore, in order to reach the target power amount Pf by the target time point Tf by using the charger of the charging power Cw, the actual power amount Px is required to transition in a power amount equal to or greater than the straight line L4 of the inclination Cw passing through (Tf, Pf). For this reason, in the charging management according to the embodiment, a condition in Expression (2), that is, a condition that the sum of the maximum amount p′ of power that can be charged by the target time point Tf and the actual amount Px of power that has been charged by the time point is equal to the target power amount Pf is used as a determination criterion according to the necessity of re-planning.

p′+Px=Cw(Tf−Tx)+Px=Pf (2)

Here, in Expression (2), (Tf−Tx) represents a difference between a target time point and the current time point, that is, a remaining chargeable time period. When the remaining chargeable time period is set as a remaining charging time period Δt [hour], Expression (2) can be arranged as Expression (3) below.

Px=Pf−CwΔt (3)

Therefore, in order to achieve charging up to the target power amount Pf from any time point Tx to the time point Tf which is a charging end target, the actual power amount Px at any time point Tx is required to satisfy Expression (4). Note that, under the condition represented by Expression (4), a case where the actual power amount Px is equal to the maximum amount of power that can be charged within the remaining charging time period Δt may be excluded.

Px≥Pf−CwΔt (4)

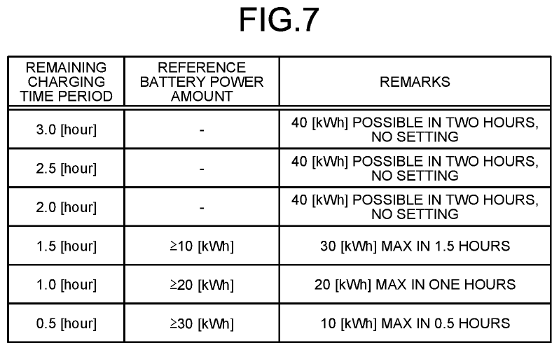

FIG. 7 illustrates the reference battery power amount set in accordance with the remaining charging time period Δt according to the embodiment. Here, the reference battery power amount is a power amount “Pf−CwΔt” [kWh] required at the time of the remaining charging time period Δt in order to achieve a target battery power amount at the time point Tf which is a charging end target. The reference battery power amount is set within a time period in which the remaining charging time period Δt is shorter than a first time period obtained by dividing the target power amount Pf by the charging power Cw of the charger used for charging the battery. Note that, in other periods to the period, zero “0” may be set as a value of the reference battery power amount. The reference battery power amount may be set when the remaining charging time period Δt is equal to the first time period. FIG. 7 illustrates the relation between the remaining charging time period Δt and the reference battery power amount under the conditions of the target power amount Pf=40 [kWh] and the charging power of a charger Cw=20 [kW] in one example. Note that the target power amount Pf=40 [kWh] corresponds to an SOC of 80[%] in the case where the maximum battery power amount is 50 [kWh], for example.

Under the conditions, charging can be performed up to 40 [kWh] of the target power amount Pf in 2.0 [hour] regardless of the actual power amount Px. Therefore, as illustrated in FIG. 7, when the remaining charging time period is 3.0 [hour], 2.5 [hour], and 2.0 [hour], the reference battery power amount is not set. That is, in the example in FIG. 7, the first time period is 2.0 [hour]. In contrast, when the remaining charging time period is 1.5 [hour], 1.0 [hour], and 0.5 [hour], a maximum amount p′ of power that can be charged in a remaining charging time period is 30 [kWh], 20 [kWh], and 10 [kWh], respectively. Therefore, when the remaining charging time period is 1.5 [hour], 1.0 [hour], and 0.5 [hour], the reference battery power amount is set to 10 [kWh], 20 [kWh], and 30 [kWh], respectively.

As described above, in the charging management according to the embodiment, the condition that the actual power amount Px at any time point Tx is equal to or greater than the difference between the target power amount Pf and the maximum amount p′ of power that can be charged after the time point is used as a determination criterion according to the necessity of re-planning. That is, the reference battery power amount as a determination criterion according to the necessity of re-planning changes in accordance with the remaining charging time period Δt. In the charging management according to the embodiment, when the actual power amount Px is equal to or greater than the reference battery power amount at the time of the remaining charging time period Δt, re-planning is determined to be unnecessary. In contrast, in the charging management according to the embodiment, when the actual power amount Px is less than the reference battery power amount at the time of the remaining charging time period Δt, re-planning is determined to be necessary. Note that, when the actual power amount Px is equal to the reference battery power amount at the time of the remaining charging time period Δt, re-planning may be determined to be necessary.

Hereinafter, operation of the management system 1 according to the embodiment will be described with reference to the drawings. Note that the flow of processing described below is one example, and it is also possible to change the processing order, delete a part of pieces of processing, and add another piece of processing.

Server-client processing is executed in the management system 1. The server-client processing is implemented by processing on the side of a server executed by the management device 3 and processing on the side of a client executed by the display terminal 2.

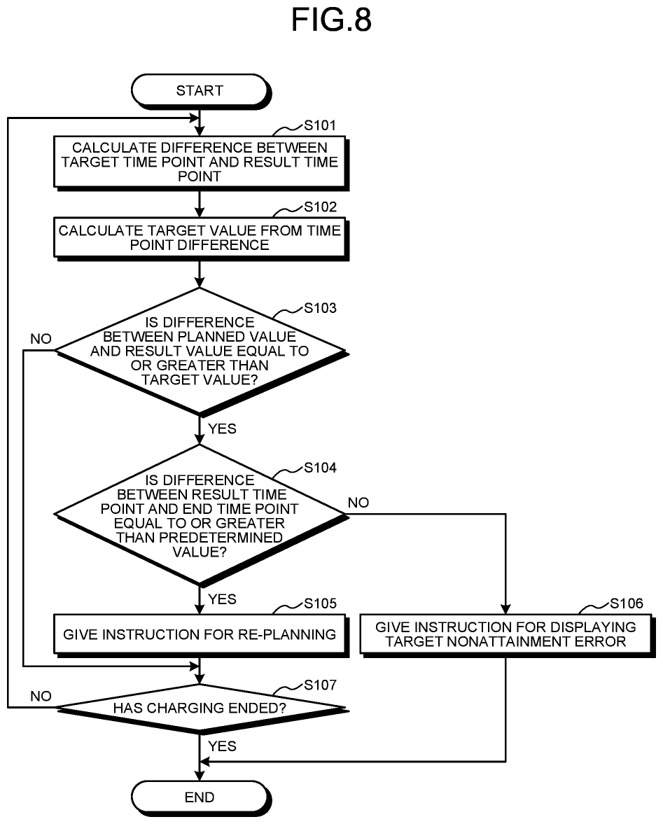

FIG. 8 is a flowchart illustrating one example of charging management processing on the side of a server executed by the management device 3 according to the embodiment.

Note that the flow in FIG. 8 is executed after the delivery planning module 301 creates a delivery plan, the power consumption predicting module 302 calculates a power consumption amount based on the delivery plan, and the charging planning module 303 creates a charging plan in accordance with the power consumption amount. Furthermore, the flow in FIG. 8 is executed after the charging management module 304 transmits the charging plan to the display terminal 2 with the transmission/reception module 306.

Furthermore, in the flow in FIG. 8, the charging management module 304 continues to transmit a charging result value received from the moving object 6 to the display terminal 2 with the transmission/reception module 306. Note that the result value may be transmitted at a preset constant cycle, or may be transmitted when a change in power amount exceeds a predetermined threshold or when a predetermined time period has elapsed since the previous transmission.

The charging management module 304 calculates the difference between the target time point Tf and the result time point Tx, that is, the remaining charging time period Δt (S101). The charging management module 304 calculates a target value, that is, the maximum power amount p′ at the remaining charging time period Δt from the remaining charging time period Δt indicating a time point difference (S102).

The charging management module 304 determines whether or not the difference between a planned value, that is, the target power amount Pf, and a result value, that is, the actual power amount Px is equal to or greater than the target value (S103). In other words, the charging management module 304 determines whether or not the actual power amount Px is less than the reference battery power amount.

When the difference between the planned value and the result value is less than the target value (S103: No), the flow in FIG. 8 proceeds to processing of S107. The case where the difference between the planned value and the result value is less than the target value includes a case where the actual power amount Px is equal to or greater than the reference battery power amount.

In contrast, when the difference between the planned value and the result value is equal to or greater than the target value (S103: Yes), the flow in FIG. 8 proceeds to processing of S104. The case where the difference between the planned value and the result value is equal to or greater than the target value includes a case where the actual power amount Px is less than the reference battery power amount. As described above, when the actual power amount Px is less than the reference battery power amount, re-planning of a charging plan is necessary for achieving the target power amount Pf. The charging management module 304 determines whether or not the difference between a result time point, that is, the current time point Tx and an end time point is equal to or greater than a predetermined second time period (S104). In other words, the charging management module 304 determines whether or not the re-planning, that is, a charging plan for achieving the target power amount Pf by the end time point can be created.

When the difference between the result time point and the end time point is equal to or greater than the predetermined second time period (S104: Yes), the flow in FIG. 8 proceeds to processing of S105. The charging management module 304 transmits a notification of re-planning to the display terminal 2, and instructs the display terminal 2 to display a display screen including the notification of re-planning. Furthermore, the charging management module 304 instructs the charging planning module 303 to re-plan a charging plan (S105). Then, the flow in FIG. 8 proceeds to processing of S107.

Note that the charging management module 304 may determine whether or not to instruct the charging planning module 303 to re-plan a charging plan in accordance with a result of user input to the display terminal 2 in the processing of S105.

In contrast, when the difference between the result time point and the end time point is shorter than the predetermined second time period (S104: No), the flow in FIG. 8 proceeds to processing of S106. The charging management module 304 transmits a notification of a target nonattainment error to the display terminal 2, and instructs the display terminal 2 to display a display screen including the notification of a target nonattainment error (S106). Note that the notification of a target nonattainment error may be displayed when the difference between the result time point and the end time point is equal to a predetermined value. Then, the flow in FIG. 8 ends.

Note that the charging management module 304 may continue charging until the end time point after the processing of S106.

The charging management module 304 determines whether or not charging has ended (S107). In the determination, for example, when the actual power amount Px reaches the target power amount Pf, and when the current time point Tx reaches the target time point Tf or the end time point, the charging management module 304 determines that the charging has ended. When the charging has not ended (S107: No), the flow in FIG. 8 returns to the processing of S101. In contrast, when the charging has ended (S107: Yes), the charging management module 304 transmits a notification of charging end to the display terminal 2. Then, the flow in FIG. 8 ends.

Note that the flow in FIG. 8 may be started when the time point at which the reference battery power amount described with reference to FIG. 7 is set has come. Specifically, the charging management module 304 starts the processing of S101 after waiting until the time period obtained by dividing the target power amount Pf by the charging power Cw of the charger has elapsed since the start of charging. This is based on the fact that charging can be performed up to the target power amount Pf at the target time point Tf regardless of the actual power amount Px during the period until the time period obtained by dividing the target power amount Pf by the charging power Cw of the charger has elapsed since the start of charging. In this case, the processing amount in the management device 3 can be reduced.

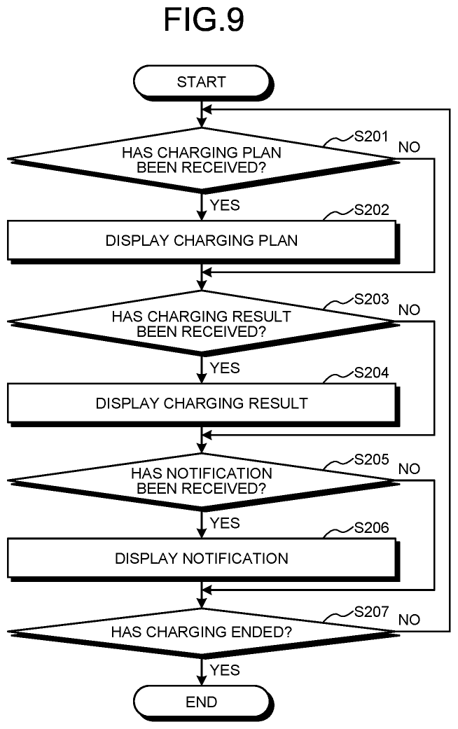

FIG. 9 is a flowchart illustrating one example of charging management processing on the side of a client executed in the display terminal 2 according to the embodiment.

The display module 202 determines whether or not the transmission/reception module 201 has received a charging plan from the management device 3 (S201). Here, the charging plan from the management device 3 has been created before the start of the flow in FIG. 9 or re-planned in S105 in FIG. 8.

When receiving the charging plan from the management device 3 (S201: Yes), the display module 202 displays a display screen including the received charging plan on the display 24 (S202). Then, the flow in FIG. 9 proceeds to processing of S203. Furthermore, when the charging plan from the management device 3 has not been received (S201: No), the flow in FIG. 9 proceeds to the processing of S203.

The display module 202 determines whether or not the transmission/reception module 201 has received a charging result from the management device 3 (S203). When receiving the charging result from the management device 3 (S203: Yes), the display module 202 displays a display screen 810 further including the received charging result on the display 24 (S204). Then, the flow in FIG. 9 proceeds to processing of S205. Furthermore, when the charging result from the management device 3 has not been received (S203: No), the flow in FIG. 9 proceeds to the processing of S205.

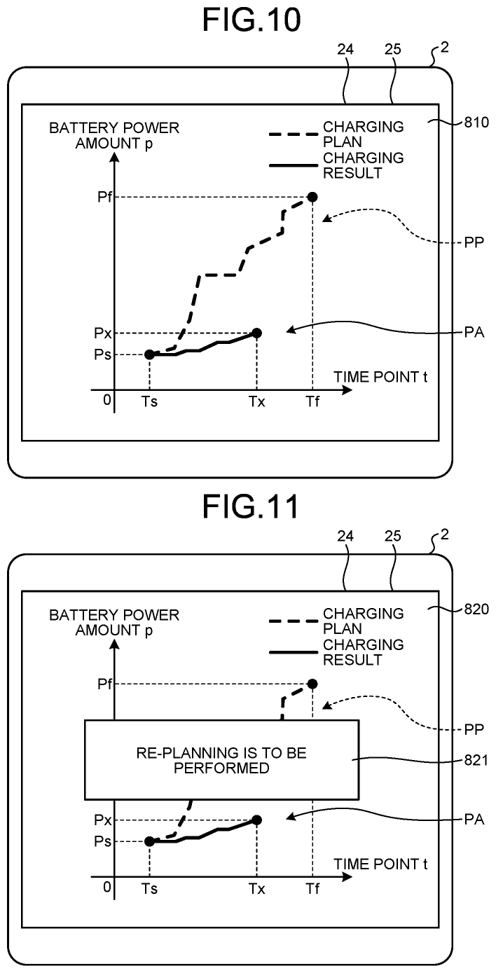

FIG. 10 illustrates one example of the display screen 810 of the display terminal 2 according to the embodiment. As illustrated in FIG. 10, the display screen 810 includes the charging plan PP and the charging result PA. The charging plan PP and the charging result PA are displayed on the display screen 810 by a graph indicating a time change in battery power amount, for example. Furthermore, the display screen 810 includes the time point Ts at which charging starts, the battery power amount Ps at the time point Ts, the current time point Tx, the battery power amount Px at the time point Tx, the target time point Tf, and the battery power amount Pf at the time point Tf.

The display module 202 determines whether or not the transmission/reception module 201 has received a notification from the management device 3 (S205). When receiving the notification from the management device 3 (S205: Yes), the display module 202 displays display screens 820 and 830 further including the received notification on the display 24 (S206). Then, the flow in FIG. 9 proceeds to processing of S207. Furthermore, when the notification from the management device 3 has not been received (S205: No), the flow in FIG. 9 proceeds to the processing of S207.

FIG. 11 illustrates one example of the display screen 820 of the display terminal 2 according to the embodiment. As illustrated in FIG. 11, the display screen 820 further includes a notification 821 indicating that re-planning is to be performed. FIG. 11 illustrates the notification 821 of re-planning of “re-planning is to be performed”.

Note that the display module 202 may display not only the notification 821 indicating that re-planning is to be performed but a notification for confirming whether or not to perform re-planning with a user. In one example, the display module 202 may display an operation button for approving execution of re-planning and an operation button for denying execution of re-planning. In this case, the transmission/reception module 201 may transmit a result of user input or selection received by the input module 203 to the management device 3.

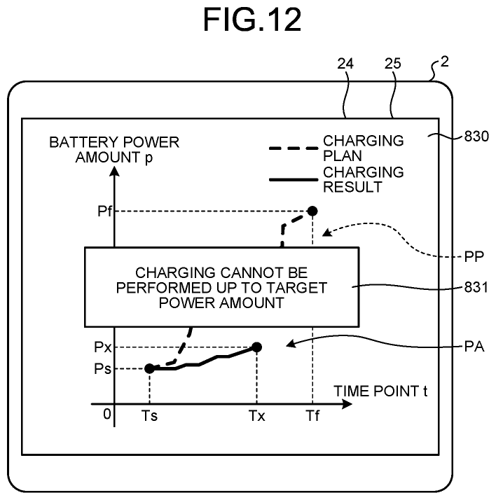

FIG. 12 illustrates one example of the display screen 830 of the display terminal 2 according to the embodiment. As illustrated in FIG. 12, the display screen 830 further includes a notification 831 of a target nonattainment error. FIG. 12 illustrates the notification 831 of a target nonattainment error of “charging cannot be performed up to target power amount”.

The display module 202 determines whether or not charging has ended (S207). In the determination, for example, when receiving a notification of charging end from the management device 3 with the transmission/reception module 201, the display module 202 determines that charging has ended. When the charging has not ended (S207: No), the flow in FIG. 9 returns to the processing of S201. In contrast, when the charging has ended (S207: Yes), the flow in FIG. 9 ends.

Note that the display screens 810, 820, and 830 may display a time change in reference battery power amount. More specifically, the display screens 810, 820, and 830 may display the straight line L4 in FIG. 6. In this case, the user can visually and easily grasp whether or not the charging result has a sufficient value at any time.

Note that the display screens 810, 820, and 830 may further display information indicating that whether a displayed charging plan has been created before the charging start or re-planned in accordance with the charging result. Furthermore, the display screens 810, 820, and 830 may further display the end time point. Furthermore, the display screens 820 and 830 are not required to display the charging plan and the charging result. Furthermore, the display screen 830 may further display an expected power amount in the case where charging is continued until the end time point without re-planning.

Note that the display module 202 may generate image data for the display screens 810, 820, and 830, or the management device 3 may generate the image data.

As described above, in the management device 3 of the embodiment, the charging planning module 303 creates a charging plan for inhibiting battery deterioration based on power consumption of the moving object 6 predicted from a delivery plan and characteristics of a battery mounted on the moving object 6. Furthermore, in charging to the battery of the moving object 6 performed in accordance with the charging plan, when the remaining charging time period Δt is shorter than the predetermined first time period, the charging management module 304 determines whether the charging plan is replanned based on the reference battery power amount calculated in accordance with the remaining charging time period Δt. The remaining charging time period Δt is a remaining time period up to the target time point Tf at which the target power amount Pf indicated by the charging plan is achieved.

According to this configuration, the determination criterion of the necessity of re-planning in the power amount Px at any time point Tx can be set in accordance with the remaining charging time period Δt. Therefore, according to the technology of the embodiment, a charging plan can be re-planned before a situation in which the actual power amount Px cannot reach the target power amount Pf occurs. Therefore, according to the technology of the embodiment, even when a charging result is insufficient for a charging plan, the re-planning of a charging plan can appropriately supplement an insufficient power amount. In other words, the management device 3 according to the embodiment can appropriately manage an actual power amount of a battery in charging in consideration of inhibiting battery deterioration by determining whether a charging plan is replanned based on a reference battery power amount set in accordance with the remaining charging time period Δt.

Note that the technology according to the present disclosure can also have the following configurations.

(1) A display terminal that displays:

a time change in power amount of a plan indicated by a charging plan for inhibiting battery deterioration created based on power consumption of the moving object 6 predicted from a delivery plan and characteristics of a battery mounted on the moving object 6; and a time change in actual power amount Px in charging to the battery performed in accordance with the charging plan.

(2) The display terminal according to (1) that displays the notification 821 of re-planning indicating that re-planning is to be performed when the remaining charging time period Δt is shorter than a predetermined first time period and a battery power amount at a time point is shorter than a reference battery power amount calculated in accordance with the remaining charging time period Δt, in charging to the battery performed in accordance with the charging plan.

(3) The display terminal according to (1) or (2) that displays the notification 831 of a target nonattainment error indicating that the actual power amount Px does not reach the target power amount Pf by the target time point Tf when a remaining time period to the end time point of charging to the battery specified by the delivery plan is shorter than a predetermined second time period.

A program executed by each of the display terminal 2, the management device 3, and the moving object 6 according to the embodiment is provided by being recorded in a computer-readable recording medium such as a CD-ROM, an FD, a CD-R, and a DVD in an installable format or an executable format.

Furthermore, the program executed by each of the display terminal 2, the management device 3, and the moving object 6 according to the embodiment may be provided by being stored in a computer connected to a network such as the Internet and downloaded via the network. Furthermore, the program executed by each of the display terminal 2, the management device 3, and the moving object 6 according to the embodiment may be provided or distributed via a network such as the Internet.

Furthermore, the program executed by each of the display terminal 2, the management device 3, and the moving object 6 according to the embodiment may be provided by being preliminarily incorporated in a ROM and the like.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A charging management device comprising:
a memory; and
a processor coupled to the memory and configured to:
create a charging plan for inhibiting deterioration of a battery mounted on a moving object based on power consumption of the moving object predicted from a delivery plan and a characteristic of the battery; and
determine whether the charging plan is replanned based on a reference battery power amount calculated in accordance with a remaining time period up to a target time point at which a target power amount indicated by the charging plan is achieved, when the remaining time period is shorter than a predetermined first time period in charging to the battery performed in accordance with the charging plan.

2. The charging management device according to claim 1, wherein the processor is configured to determine, when a power amount of the battery at a current time point is smaller than the reference battery power amount, that the charging plan is replanned.

3. The charging management device according to claim 1, wherein the processor is configured to calculate, as the first time period, a time period obtained by dividing the target power amount by charging power of a charger used for charging the battery.

4. The charging management device according to claim 2, wherein the processor is configured to calculate, as the first time period, a time period obtained by dividing the target power amount by charging power of a charger used for charging the battery.

5. The charging management device according to claim 1, wherein the processor is configured to calculate a product of the remaining time period and charging power of a charger used for charging the battery, and calculate a difference between the target power amount and the product as the reference battery power amount.

6. The charging management device according to claim 2, wherein the processor is configured to calculate a product of the remaining time period and charging power of a charger used for charging the battery, and calculate a difference between the target power amount and the product as the reference battery power amount.

7. The charging management device according to claim 1, wherein, when the remaining time period is equal to or greater than the first time period, the processor is configured to determine that the charging plan is not replanned.

8. The charging management device according to claim 2, wherein, when the remaining time period is equal to or greater than the first time period, the processor is configured to determine that the charging plan is not replanned.

9. The charging management device according to claim 1, wherein, when a remaining time period up to an end time point of charging to the battery specified by the delivery plan is equal to or greater than a predetermined second time period, the processor is configured to determine that the charging plan is replanned.

10. The charging management device according to claim 2, wherein, when a remaining time period up to an end time point of charging to the battery specified by the delivery plan is equal to or greater than a predetermined second time period, the processor is configured to determine that the charging plan is replanned.

11. The charging management device according to claim 1, wherein the processor is configured to charge the battery in accordance with the charging plan before delivery to be performed in accordance with the delivery plan.

12. The charging management device according to claim 2, wherein the processor is configured to charge the battery in accordance with the charging plan before delivery to be performed in accordance with the delivery plan.

13. The charging management device according to claim 1, wherein the processor is further configured to create the delivery plan including a delivery course for inhibiting deterioration of the battery based on destination information on a plurality of destinations and accumulated battery data.

14. The charging management device according to claim 2, wherein the processor is further configured to create the delivery plan including a delivery course for inhibiting deterioration of the battery based on destination information on a plurality of destinations and accumulated battery data.

15. A charging management system comprising:
the charging management device according to claim 1; and
a display terminal configured to display a time change in power amount indicated by the charging plan and a time change in actual power amount of the battery.

16. The charging management system according to claim 15, wherein
when it is determined that the charging plan is replanned, the charging management device outputs a notification of re-planning indicating that the re-planning is to be performed, and
the display terminal displays the notification of re-planning output from the charging management device.

17. The charging management system according to claim 15, wherein
the charging management device determines that the charging plan is not replanned when a remaining time period up to an end time point of charging to the battery specified by the delivery plan is shorter than a predetermined second time period, and outputs a notification of a target nonattainment error indicating that a power amount of the battery does not reach the target power amount by the target time point, and
the display terminal displays the notification of the target nonattainment error output from the charging management device.

18. The charging management system according to claim 16, wherein
the charging management device determines that the charging plan is not replanned when a remaining time period up to an end time point of charging to the battery specified by the delivery plan is shorter than a predetermined second time period, and outputs a notification of a target nonattainment error indicating that a power amount of the battery does not reach the target power amount by the target time point, and
the display terminal displays the notification of the target nonattainment error output from the charging management device.

19. A charging management method comprising:
creating a charging plan for inhibiting deterioration of a battery mounted on a moving object based on power consumption of the moving object predicted from a delivery plan and a characteristic of the battery; and
determining whether the charging plan is replanned based on a reference battery power amount calculated in accordance with a remaining time period up to a target time point at which a target power amount indicated by the charging plan is achieved, when the remaining time period is shorter than a predetermined first time period in charging to the battery performed in accordance with the charging plan.
